(19) United States
(12) Patent Application Publication
(10) Pub. No.: US 2008/0252148 A1
(43) Pub. Date: Oct. 16, 2008

(54) SEPARATED BATTERY AND VEHICLE VOLTAGES

(76) Inventor: Ross D. Pursifull, Dearborn, MI (US)

Correspondence Address: VISTEON/BRINKS HOFER GILSON & LIONE, 524 South Main Street, Suite 200, Ann Arbor, MI, 48104, US

(21) Appl. No.: 11/734,304

(22) Filed: Apr. 12, 2007

(51) Int. Cl. H02J 7/34

(52) U.S. Cl. 307/81; 322/28

(57) ABSTRACT

A power distribution system and method of operation, for a motor vehicle. The power distribution system includes a generator is in a parallel electrical connection with a battery and a switch. The generator is also in communication with a vehicle load circuit, while the battery is in selective communication with the generator based on the state of the switch. The switch disconnects the battery from the vehicle load circuits to isolate the battery from the vehicle load circuit and the generator output voltage, and allowing the generator to run at a voltage below the nominal battery voltage. The method includes the steps of disconnecting the battery from the generator and vehicle load, lowering the generator output voltage from the generator, and providing the generator output voltage to the vehicle circuit.

### BACKGROUND

1. Field of the Invention

The present invention generally relates to a power distribution system for a motor vehicle.

2. Description of Related Art

Improving fuel economy has been a concern of the automotive industry for many years. Motor vehicles typically include a generator to create electrical power. The generator may be driven by a gas engine or any other engine that propels the vehicle. To maximize vehicle fuel economy, the vehicle's electrical consumption needs to be minimized. Since the vehicle electrical loads can be roughly approximated as resistive loads, lowering the vehicle's voltage reduces the power consumption. Reducing the power consumption, in turn lessens the load on the engine and increases fuel economy. However, lowering the vehicle operating voltage below the battery voltage, may result in battery discharge. Accordingly, recharging the battery would again increased the load on the generator negatively affecting fuel economy.

In view of the above, it is apparent that there exists a need for an improved power distribution system for a motor vehicle that overcomes the drawbacks and limitations of the known technology.

### SUMMARY

In satisfying the above need, as well as overcoming the enumerated drawbacks and other limitations of the related art, the present invention provides an improved power distribution system for a motor vehicle.

Typical vehicle power distribution systems include a direct connection from the battery to the generator. In one embodiment of the present invention, the direct connection from the battery to the generator may be eliminated. In this instance the central voltage node for vehicle power is connected directly to the generator output. Meanwhile, the central voltage node for vehicle power is connected to the battery output via a normally closed switch. When the generator produces sufficient voltage to supply the vehicle's power draw, the switch is opened. When the generator does not produce sufficient voltage, the switch is closed. The starter motor remains connected to the battery regardless of the switch position.

In a second embodiment, the battery charging is handled via a battery charger that is powered from the vehicle's central voltage node when the relay is opened. For example, if a DC to DC converter were employed, battery charging could occur at vehicle voltages lower than the battery's operating voltage. These configurations allow the battery to function as an ancillary current source. The battery would be connected to the vehicle's central voltage node during key off, engine start, and when the vehicle's electrical load exceeded the generator's ability to source sufficient current. Accordingly, battery charging would be handled independently from vehicle voltage regulation.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a power distribution system in accordance with the principles of the present invention;

FIG. 2 is a flow chart illustrating a method for controlling the power distribution system of FIG. 1;

FIG. 3 is another embodiment of the power distribution system in accordance with the present invention; and

FIG. 4 is flow chart illustrating a method for controlling a power distribution system of FIG. 3.

### DETAILED DESCRIPTION

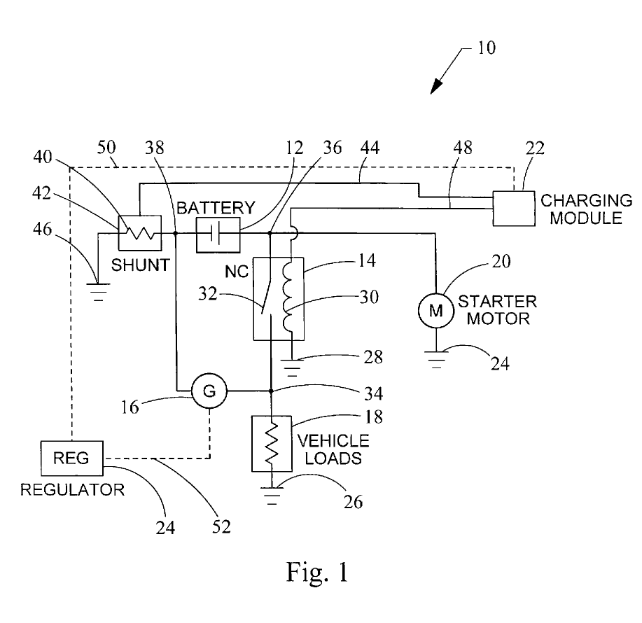

Referring now to FIG. 1, a system embodying the principles of the present invention is illustrated therein and designated at 10. The system 10 includes as its main components a battery 12, a generator 14, a switch 16, and a vehicle load circuit 18.

The battery 12 may be a typical 12 volt vehicle battery as is commonly found in motor vehicles. However, other electrical storage devices may also be used. The battery 12 is connected in an electrical parallel connection with the generator 16, which may be driven by the vehicle engine (not shown). While the vehicle is turned off, the battery 12 provides power to the vehicle load circuit 18 as needed. The vehicle load circuit 18 may include a variety of the typical vehicle loads, such as, windshield wipers, defrosters, entertainment systems, climate control systems, or other electrical vehicle systems.

Current is provided to the vehicle load circuit 18 from the battery 12 through the switch 14, which is preferably a solenoid driven mechanical relay, however, other relays, such as solid state relays, may be used. As shown in FIG. 1, the switch 14 is a normally closed solenoid driven relay and includes a mechanical contact 32 and a coil 30. Therefore, when the vehicle is powered off, the contact 32 is closed and power from the battery 12 is provided to the vehicle load circuit 18 when necessary. The state of the contact 32 is manipulated by energizing the coil 30, which is controlled by the charging module 22. The charging module 22 provides a voltage over line 48 to energize the coil 30, thereby opening contact 32 and disconnecting the battery 12 from the vehicle load circuit 18. While a first end of the coil 30 is connected to the charging module 22, a second end of the coil 30 is connected to an electrical reference 28, such as an electrical ground, to complete the electrical circuit.

The positive side of the battery 12 is connected to the switch 14 at a first node 36. In addition, a motor starter 20 may also be connected between the first node 36 and an electrical reference 24, such as an electrical ground. As such, the battery 12 may remain in electrical communication with the motor starter 20 to provide the motor starter with current required during engine start-up. The negative side of the battery 12 is connected to a second node 38. The generator 16 is connected between the second node 38 and a third node 34. As such, the generator 16 is connected in an electrical parallel connection with the battery 12 and the switch 14, between the second node 38 and the third node 34.

The vehicle load circuit 18 is in electrical communication with the generator 16 and selective electrical communication with the battery 12 through the third node 34. The vehicle load circuit 18 may further be connected between node 34 and electrical reference 26, such as electrical ground, to complete the electrical circuit.

Referring again to the second node 38, the negative side of the battery and the negative side of the generator 16 may be connected to a reference voltage 46, such as electrical ground, through a shunt resistor 40. The shunt resistor may be connected between node 38 and electrical reference 46. A voltage measurement device 42 may be connected across shunt 40 to determine the amount of current being drawn through the battery 12 and generator 16 by various vehicle systems. The voltage measurement device 42 is connected to the charging module 22, as denoted by line 44. Accordingly, the charging module 22 may control the state of switch 14 based on the measured current draw. The charging module 22 may utilize various technologies for determining the state of charge of the battery 12 including, but not limited to, sensing the battery current, performing a precision reading of the voltage during a wakeup mode, or similar methodologies. If charging is required, charging may be performed by simply closing the switch 14 and connecting the battery 12 to node 34. Various charging methodologies, including, for example, pulse charging, float charging, rapid charging, or temperature compensated charging, may be used to change the battery 12.

In addition, the charging module 22 is in communication with a regulator 24, as denoted by line 50, and the regulator 24 is in communication with the generator 16, as denoted by line 52. By providing the regulator 24 in this manner, the output voltage provided by the generator 26 to node 34 may be adjusted. Accordingly, through the regulator 24, the charging module 22 may manipulate the output voltage of the generator 16 based on the measured current through the shunt resistor 40.

In the configuration shown in FIG. 1, the switch 14 would simply disconnect the battery 12 from the generator 16 once the battery 12 is charged. From that point on, the generator output voltage can be chosen based on the vehicle system needs without affecting the charging or discharging of the battery 12. For example, one could operate the generator output voltage close to ten (10) volts if the headlights are off. Unlike the preceding example, known charging systems cannot continuously operate below a voltage of approximately 12.4 volts because doing so would discharge the battery 12.

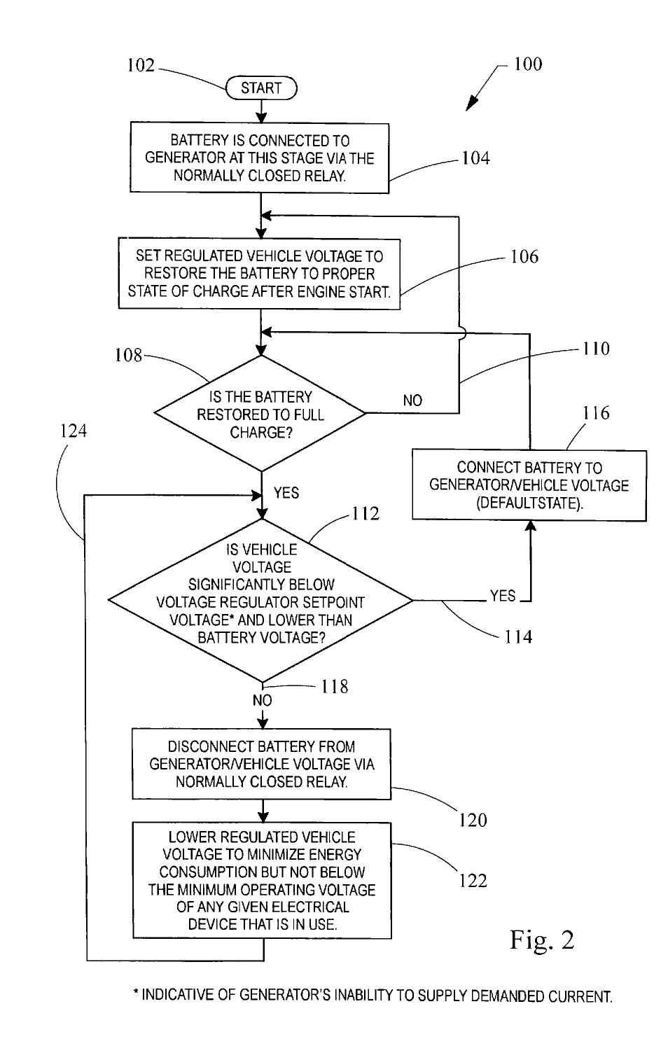

Now referring to FIG. 2, a method 100 for controlling the power distribution system 10 of FIG. 1 is provided. The method 100 begins in block 102 and proceeds to block 104 where the battery 12 is connected to the generator 16 through switch 14. As noted above, the switch 14 may be configured as a normally closed relay. In block 106, the charging module 22 is configured to set the regulated vehicle voltage to the nominal battery voltage, for example, about 14.5 volts. Accordingly, the generator 16 provides current to the battery, 12 through switch 14 to recharge the battery 12, replacing energy used by the starter motor 20 during starting of the engine. In block 108, the charging module 22 determines if the battery is restored to full charge. If the battery is not restored to full charge, the method follows line 110 to block 106 and current is provided so as to recharge the battery 12. Alternatively, if the battery is fully charged, the method follows line 111 to block 112. In block 112, the charging module 22 determines if the vehicle operating voltage, for example at node 34, is significantly below the voltage regulator set point voltage (which is determined by the regulator 24 and indicative of the generator's 16 inability to supply the demanded current) and lower than the nominal battery voltage of the battery 12. If the vehicle voltage is significantly below the voltage regulator set point voltage and lower than the battery voltage, the method follows line 114 to block 116. In block 116, the charging module 22 adjusts the state of the switch 14 to connect the battery 12 to the generator 16. The method 100 then proceeds back to block 108. If the vehicle voltage is not significantly below the voltage regulator set point voltage or not lower than the nominal battery voltage, the method 100 follows line 118 to block 120. In block 120, the switch 14 disconnects the battery 12 from the generator 16 and the method proceeds to block 122. In block 122, the charging module 22 lowers the generator output voltage through the regulator 24 to minimize energy consumption. However, the generator output voltage is not lowered below the minimum operating voltage of any given electrical device in the vehicle load circuit 18 that is in use. The method 100 then follows line 124 and loops back to block 112 where the method 100 continues.

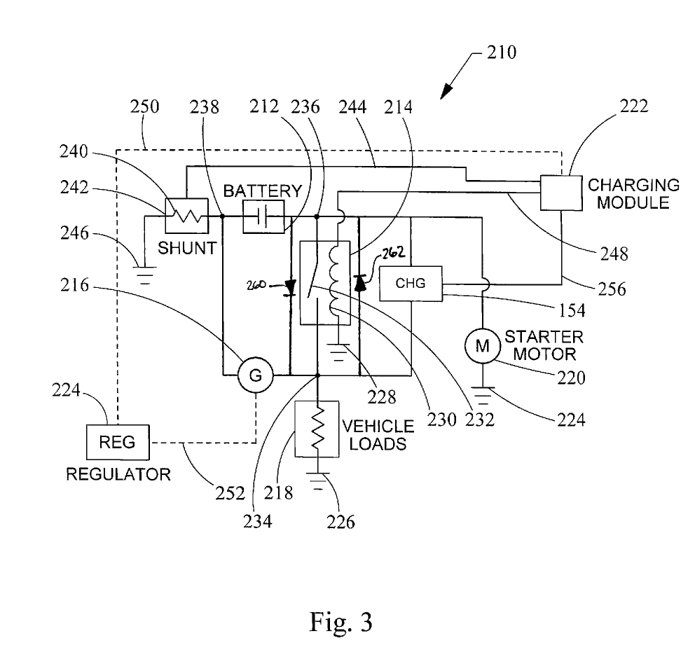

Now referring to FIG. 3, in another embodiment, a converter 254 may be provided to charge a battery 212 when a switch 214 is open. The battery 212 is connected in an electrical parallel connection with a generator 216. The battery 212 may provide current to a vehicle load circuit 218 through the switch 214 when the switch is closed. Preferably, the switch 214 is a normally closed relay including a mechanical the contact 232 and a coil 230. Therefore, when the vehicle is powered off, contact 232 is closed providing power from the battery 212 to the vehicle load circuit 218. A charging module 222 provides a voltage over line 248 to energize the coil 230 thereby opening the contact 232 to disconnect the battery 212 from the vehicle load circuit 218. Accordingly, a first end of coil 230 is connected to the charging module 222 and a second end of coil 230 is connected to an electrical reference 228, such as an electrical ground.

The positive side of the battery 212 is connected to the switch 214 at a first node 236. In addition, a motor starter 220 may also be connected between the first node 236 and an electrical reference 224, such as an electrical ground. As such, the battery 212 may remain in electrical communication with the motor starter 220 to provide the current required during engine start-up. The negative side of the battery 212 is connected to a second node 238. The generator 216 may be connected between the second node 238 and a third node 234. As such, the generator 216 is connected in an electrical parallel connection with the battery 212 and the switch 214 between the second node 238 and the third node 234. The vehicle load circuit 218 is in electrical communication with the generator 216 and in selective electrical communication with the battery 212 at the third node 234. Further, the vehicle load circuit 218 may be connected between node 234 and electrical reference 226, such as electrical ground, to complete the electrical circuit.

Further, a first diode 260 is connected between node 236 and node 234. The first diode 260 is oriented with the anode connected to node 236 and the cathode connected to node 234. Similarly, a second diode 262 is also connected between node 236 and node 234. The second diode 262 is oriented with the cathode connected to node 236 and the anode connected to node 234.

Referring again to the second node 238, the negative side of the battery and the negative side of the generator 216 may be connected to a reference voltage 246, such as electrical ground through a shunt resistor 240. As such, the shunt resistor 240 may be connected between node 238 and electrical reference 246. A voltage measurement device 242 may be connected across shunt 240 to determine the amount of current drawn by various vehicle systems through the battery 212 and generator 216. This voltage measurement device 242 is connected to the charging module 222 as denoted by line 244. Accordingly, the charging module 222 may control the state of switch 214 based on the measured current draw.

The charging module 222 may utilize various technologies for determining the state of battery charge including, but not limited to, sensing the battery current, performing a precision reading of the voltage during a wakeup mode, or similar methodologies. Charging may be achieved using various charging methodologies including, for example, pulse charging, float charging, rapid charging, or temperature compensated charging and may be performed by simply closing the switch 214 and connecting the battery 212 to node 234.

Additionally, the charging module 222 is in communication with a regulator 224 as denoted by line 250. In turn, the regulator 224 is in communication with the generator 216, as denoted by line 252, to adjust the generator output voltage provided to node 234. Accordingly, through the regulator 224, the charging module 222 may manipulate the output voltage of the generator 216 based on the measured current through the shunt resistor 240.

The converter 254 is provided in electrical parallel connection with the switch 214, between the first node 236 and the third node 234. The converter 254 is also in electrical communication with the charging module 222, along line 256, such that the charging module 222 can enable or disable the converter 254. When the converter 254 is enabled, the voltage output from the generator 216 may be converted, for example, to a higher voltage to recharge the battery 212 when the switch 214 is in the open state and the regulator 224 is causing the generator 216 to provide a generator output voltage lower than the nominal battery voltage.

In the configuration shown in FIG. 3, the system would charge the battery 212 using the converter 254, such as a DC to DC converter, while the voltage regulator 224 sets the vehicle voltage below the desired charging voltage. This implementation effectively separates the battery charging from selecting a vehicle voltage regulation point the entire time the engine is running. This also allows for the battery charge voltage and consequently the battery charge rate to be selected independently from the vehicle operating voltage. For example, the switch 214 may be sized for a key-on current of 60-100 amps. In a worst-case scenario, there is a battery current draw and the generator provides no current. The battery 212, however, can recover the energy required to drive the starter motor 220 in about 20 seconds. Therefore, little time is spent in the battery charging mode. Further, the system 200 is particularly useful during headlights operation, where of the system voltage needs to be 14.5 volts. In this condition, the system 200 prevents excess battery charging current. In addition to the above, the system 200 improves the battery life by eliminating over charging and therefore increases fuel economy. The system 200 may also extend incandescent bulb life by limiting the maximum voltage at which the bulbs will operate.

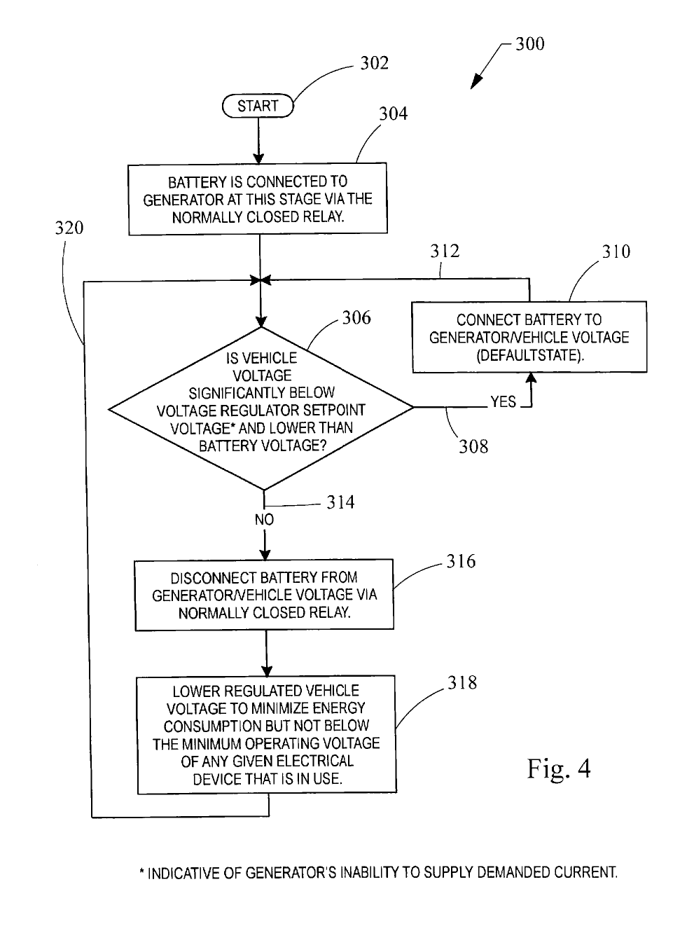

Referring now to FIG. 4, a method 300 is provided to control a power distribution system, such as one shown in FIG. 3. The method begins in block 302 and proceeds to block 304 where the battery 212 is connected to the generator 216 through switch 214. As noted above the switch 214 may be configured as a normally closed relay. In block 306, the charging module 222 determines if the vehicle operating voltage, for example at node 234, is significantly below the voltage regulator set point voltage (as determined by the regulator 224) and lower than the nominal battery voltage of the battery 212. If the vehicle voltage is significantly below the voltage regulator set point and lower than the battery voltage, the method follows line 308 to block 310. In block 310, the charging module 222 adjusts the state of the switch 214 to connect the battery 212 to the generator 216. The method 300 then proceeds back to block 306. If the vehicle voltage is not significantly below the regulator set point voltage or not lower than the nominal battery voltage, the method follows line 314 to block 316. In block 316, the switch 214 disconnects the battery 212 from the generator 216. Proceeding to block 318, the charging module 222 lowers the generator output voltage through the regulator 224 to minimize energy consumption. The generator output voltage is not, however, lowered below the minimum operating voltage of any given electrical device that is in use in the vehicle load circuit 218. The method 300 then follows line 320 and loops back to block 306 where the method 300 continues.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I claim:

1. A power distribution system for a motor vehicle, the system comprising:
a battery configured to store electrical energy;
a generator in parallel electrical connection with the battery;
a vehicle load circuit in communication with the generator;
a switch connected between the battery and the vehicle load circuit, the switch being configured to disconnect the battery from the vehicle load.

2. The system according to claim 1, wherein the switch is configured to disconnect the battery from the vehicle load circuit based on the generator output voltage.

3. The system according to claim 1, wherein the switch is configured to isolate the battery from the generator.

4. The system according to claim 1, wherein the generator is connected to the vehicle load circuit at a first node, the switch being connected in electrical series with the battery between the battery and the first node.

5. The system according to claim 1, wherein the switch is configured to connect the generator to the battery during starting of the engine of the motor vehicle.

6. The system according to claim 5, wherein the switch is configured to disconnect the battery from the vehicle load circuit after the battery is restored to full charge from the engine start.

7. The system according to claim 1, wherein the switch is configured to connect the battery to the vehicle load circuit if the generator output is below a voltage regulator setpoint voltage and lower than a battery voltage.

8. The system according to claim 1, wherein the generator is configured to lower the generator output voltage when the battery is disconnected from the vehicle load circuit.

9. The system according to claim 1, further comprising a charging module configured to measure a current flow through the battery and generator, the charging module being configured to manipulate of a switch state based on the current flow.

10. The system according to claim 9, further comprising a regulator in communication with the generator and charging module to adjust the generator output voltage based on the current flow.

11. The system according to claim 1, further comprising a voltage converter connected between the generator and the battery, the voltage converter being configured to charge the battery when the operating voltage is lower than a nominal battery voltage.

12. The system according to claim 1, further comprising a voltage converter connected between the generator and the battery, the voltage converter being configured to charge the battery when the switch is open.

13. A method for controlling a power distribution system for motor vehicle, the method comprising:
providing a battery and a generator in communication with a vehicle load circuit;
disconnecting the battery from the generator and the vehicle load;
lowering a generator output voltage of the generator; and
providing the generator output voltage to the vehicle load circuit.

14. The method according to claim 13, wherein the step of the disconnecting of the battery from the generator and vehicle load is based on the generator output voltage.

15. The method according to claim 13, wherein the step of disconnecting the battery from the generator and vehicle load is done after the battery has been restored to full charge from an engine start.

16. The method according to claim 13, further comprising the step of connecting the battery to the vehicle load circuit if the generator output voltage is below a voltage regulator setpoint voltage and lower than a predetermined battery voltage.

17. The method according to claim 13, further comprising the steps of measuring a current flow through the battery and generator, and disconnecting the battery based on the current flow.

18. The method according to claim 17, further comprising the steps of measuring a current flow through the battery and generator, and lowering the generator output voltage based on the current flow.

19. The method according to claim 13, further comprising the steps of providing a voltage converter and charging the battery through the voltage converter when the battery is disconnected from the vehicle load circuit.
